(19) United States
(12) Patent Application Publication
(10) Pub. No.: US 2022/0136641 A1
(43) Pub. Date: May 5, 2022

(54) PIPELINE MEMBRANES

(71) Applicant: DMX Plastics Limited, Brampton (CA)

(72) Inventor: Sundeepan Sennik, Thornhill (CA)

(21) Appl. No.: 17/452,245

(22) Filed: Oct. 26, 2021

Related U.S. Application Data
(60) Provisional application No. 63/110,327, filed on Nov. 5, 2020.
(60) Provisional application No. 63/166,462, filed on Mar. 26, 2021.

(51) Int. Cl. F16L 59/07; F16L 59/075; F16L 59/08

(52) U.S. Cl. CPC F16L 59/07; F16L 59/08; F16L 59/075

(57) ABSTRACT

A membrane for installation circumferentially about a pipe includes: (a) a substrate including: (i) a panel having an underside surface on an underside of the substrate for facing the pipe and a topside surface on a topside of the substrate opposite the underside, (ii) a plurality of underside protrusions projecting form the underside surface for supporting the panel radially apart from the pipe; and (iii) a plurality of topside protrusions projecting from the topside surface. The membrane further includes (b) a foam layer extending over the topside of the substrate; and (c) a heat-reflecting layer extending over the foam layer.

### CROSS-REFERENCE TO RELATED APPLICATIONS

This application claims the benefit of U.S. Provisional Application No. 63/110,327, filed Nov. 5, 2020, and U.S. Provisional Application No. 63/166,462, filed Mar. 26, 2021, each of which is hereby incorporated herein by reference in its entirety.

### FIELD

The specification relates generally to pipelines, and more specifically to membranes for pipelines.

### BACKGROUND

U.S. Pat. 9,869,100 (Sennik) discloses an underlayment for a floor. The underlayment includes a dimpled substrate having a generally planar top side, an opposed bottom side, and a plurality of dimples formed therein. Each dimple is bounded by a dimple wall, and includes a dimple opening along the top side. A smoothing layer is bonded to the top side of the dimpled substrate and overlays and occludes the dimple openings.

### SUMMARY

The following summary is intended to introduce the reader to various aspects of the applicant's teaching, but not to define any invention.

According to some aspects, an insulated pipeline assembly includes: (a) a pipe for conveying a fluid therethrough; (b) an insulation layer extending circumferentially about the pipe for insulation thereof; and (c) a membrane extending circumferentially about the pipe radially intermediate the pipe and the insulation layer for providing an air gap therebetween. The membrane comprises a substrate including: (i) a panel having an underside surface facing the pipe and a topside surface opposite the underside surface. The topside surface faces the insulation layer. The membrane further includes: (ii) a plurality of underside protrusions projecting from the underside surface and supporting the panel radially apart from the pipe; and (iii) a plurality of topside protrusions projecting from the topside surface and supporting at least portions of the insulation layer radially apart from the panel. In some examples, the topside protrusions are interspersed between the underside protrusions.

In some examples, a plurality of perforations pass radially through the membrane for permitting gas permeability therethrough. In some examples, the underside protrusions support the panel radially apart from the pipe to provide an underside radial air gap therebetween, and the topside protrusions support the insulation layer radially apart from the panel to provide a topside radial air gap therebetween. The perforations provide fluid communication between the underside and topside air gaps. In some examples, at least some of the perforations pass through the protrusions. In some examples, at least some of the perforations pass through the panel.

In some examples, the membrane includes a heat reflecting layer extending over the substrate. In some examples, the heat-reflecting layer is radially intermediate the substrate and the insulating layer. In some examples, the heat-reflecting layer covers and is bonded to the panel and the protrusions. In some examples, the heat-reflecting layer comprises an aluminum lamination.

In some examples, each protrusion comprises a dimple extending from the panel to a tip spaced radially apart from the panel. In some examples, each dimple has an endwall comprising the tip, a sidewall extending from the panel to the endwall, and an interior bounded by the endwall and the sidewall. The interior of each underside protrusion is open to the topside surface of the panel, and the interior of each topside protrusion is open to the underside surface of the panel.

In some examples, the substrate is of integral, unitary, one-piece construction.

In some examples, the substrate has a substrate thickness, and the substrate thickness is between 0.2 mm and 5 mm.

In some examples, the substrate is formed from one of: polyvinyl chloride (PVC), polyethylene terephthalate (PET), polystyrene, nylon, acrylonitrile butadiene styrene (ABS), and acetal.

In some examples, the substrate is formed through one of: extrusion, thermoforming, and injection molding.

According to some aspects, a membrane is disclosed for installation circumferentially about a pipe. The membrane comprises: (a) a substrate including (i) a panel having an underside surface for facing the pipe and a topside surface opposite the underside surface, (ii) a plurality of underside protrusions projecting from the underside surface for supporting the panel radially apart from the pipe, and (iii) a plurality of topside protrusions projecting from the topside surface, the topside protrusions interspersed between the underside protrusions; and (b) a plurality of perforations passing through the substrate for providing gas permeability through the membrane.

In some examples, the membrane further includes (c) a heat reflecting layer extending over and bonded to the substrate. In some examples, the heat-reflecting layer comprising an aluminum lamination.

In some examples, the substrate is formed from one of: polyvinyl chloride (PVC), polyethylene terephthalate (PET), polystyrene, nylon, acrylonitrile butadiene styrene (ABS), and acetal.

In some examples, each protrusion comprises a dimple extending from the panel to a tip spaced radially apart from the panel. In some examples, each dimple has an endwall comprising the tip, a sidewall extending from the panel to the endwall, and an interior bounded by the endwall and the sidewall. The interior of each underside protrusion is open to the topside surface of the panel, and the interior of each topside protrusion is open to the underside surface of the panel.

According to some aspects, a pipeline assembly includes: (a) a pipe for conveying a fluid therethrough; and (b) a membrane for installation circumferentially about the pipe. The membrane comprises: (i) a substrate including a panel having an underside surface on an underside of the substrate for facing the pipe and a topside surface on a topside of the substrate opposite the underside, and a plurality of protrusions projecting from the underside surface of the panel and supporting the panel radially apart from the pipe to provide an air gap therebetween; and (ii) a topside foam layer extending over the topside of the substrate.

In some examples, the topside foam layer covers and is bonded to the topside surface of the panel and interior surfaces of the protrusions.

In some examples, the membrane further includes (iii) a heat-reflecting layer extending over the topside foam layer. In some examples, the heat-reflecting layer is bonded to the topside foam layer.

In some examples, the membrane further includes (iv) an underside foam layer on the underside of the substrate. In some examples, the underside foam layer covers and is bonded to the underside surface of the panel and exterior surfaces of the protrusions.

In some examples, the membrane further includes (v) a plurality of perforations passing radially through the membrane for permitting gas permeability therethrough. In some examples, the perforations pass through the heat-reflecting layer, the topside foam layer, sidewalls of the protrusions, and the underside foam layer.

According to some aspects, a membrane for installation circumferentially about a pipe comprises: (a) a substrate including (i) a panel having an underside surface on an underside of the substrate for facing the pipe and a topside surface on a topside of the substrate opposite the underside, and (ii) a plurality of protrusions projecting from the underside surface of the panel for supporting the panel radially apart from the pipe to provide an air gap therebetween; and (b) a topside foam layer extending over the topside of the substrate. In some examples, the membrane further includes (c) a plurality of perforations passing radially through the membrane for permitting gas permeability therethrough. In some examples, the membrane further includes (d) a heat-reflecting layer extending over the topside foam layer. In some examples, the membrane further includes (e) an underside foam layer on the underside of the substrate. In some examples, the membrane can be rolled up into a roll to facilitate packaging for storage, shipment, and/or sale.

According to some aspects, a membrane for installation circumferentially about a pipe comprises: (a) a substrate including (i) a panel having an underside surface on an underside of the substrate for facing the pipe and a topside surface on a topside of the substrate opposite the underside, (ii) a plurality of underside protrusions projecting form the underside surface for supporting the panel radially apart from the pipe; and (iii) a plurality of topside protrusions projecting from the topside surface; (b) a foam layer extending over the topside of the substrate; and (c) a heat-reflecting layer extending over the foam layer. In some examples, the foam layer is supported by the topside protrusions in spaced apart relation from the topside surface of the panel. In some examples, the membrane comprises a one-piece assembly with the heat-reflecting layer bonded to the foam layer and the foam layer bonded to the substrate. In some examples, the membrane can be rolled up into a roll to facilitate packaging for storage, shipment, and/or sale.

### BRIEF DESCRIPTION OF THE DRAWINGS

The drawings included herewith are for illustrating various examples of apparatuses, systems, and processes of the present specification and are not intended to limit the scope of what is taught in any way. In the drawings:

FIG. 1 is a schematic side view of an example pipeline assembly;

FIG. 2 is a cross-sectional view of the pipeline assembly of FIG. 1, taken along line 2-2 in FIG. 1;

FIG. 2A is an enlarged view of a portion of FIG. 2;

FIG. 3 is a top view of a portion of a membrane of the pipeline assembly of FIG. 1, shown in an unrolled configuration;

FIG. 4 is a cross-sectional view of the membrane of FIG. 3, taken along line 4-4 in FIG. 3;

FIG. 5 is a cross-sectional view like that of FIG. 4 but of another example membrane for a pipeline assembly;

FIG. 6 is a cross-sectional view of a portion of another example pipeline assembly;

FIG. 7 is a perspective view of a portion of a membrane for the pipeline assembly of FIG. 6;

FIG. 8 is an exploded view of the membrane of FIG. 7;

FIG. 9 is a cross-sectional view of a portion of the membrane of FIG. 7, taken along line 9-9 in FIG. 7; and

FIG. 9A is an enlarged view of a portion of FIG. 9.

### DETAILED DESCRIPTION

Various apparatuses, systems, or processes will be described below to provide an example of an embodiment of each claimed invention. No embodiment described below limits any claimed invention and any claimed invention may cover apparatuses, processes, or systems that differ from those described below. The claimed inventions are not limited to apparatuses, systems, or processes having all of the features of any one apparatus, system, or process described below or to features common to multiple or all of the apparatuses, systems, or processes described below. It is possible that an apparatus, system, or process described below is not an embodiment of any claimed invention. Any invention disclosed in an apparatus, system, or process described below that is not claimed in this document may be the subject matter of another protective instrument, for example, a continuing patent application, and the applicants, inventors, or owners do not intend to abandon, disclaim, or dedicate to the public any such invention by its disclosure in this document.

The present disclosure is directed to aspects of pipeline assemblies and membranes therefor that can help inhibit heat transfer between piping and external environment while promoting air flow around the piping to help prevent formation of condensation on exterior pipe surfaces that may otherwise lead to premature corrosion or other problems.

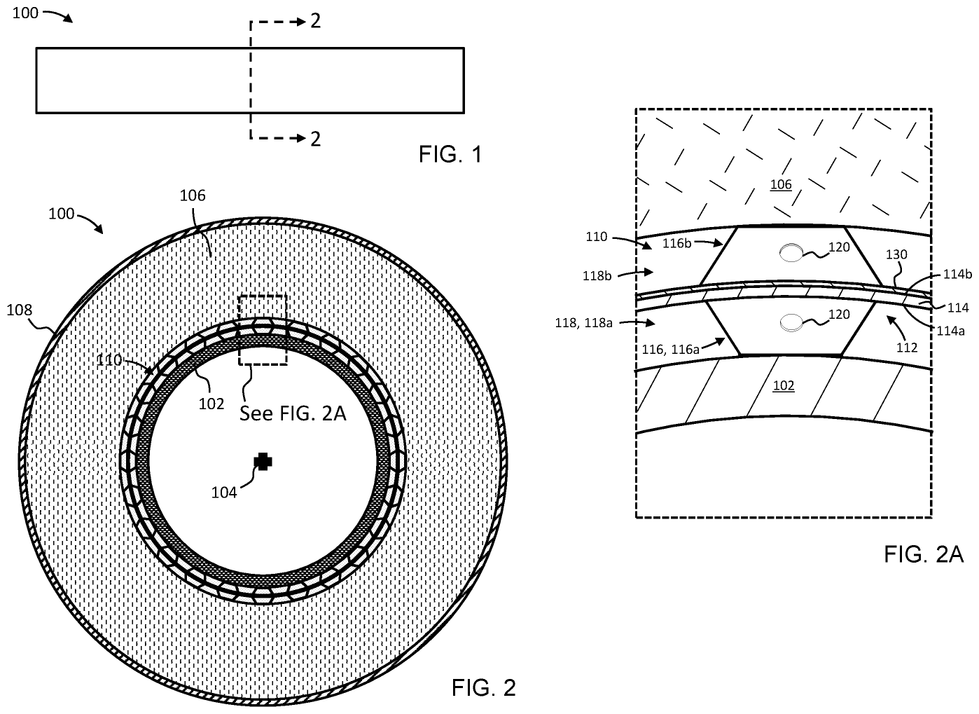

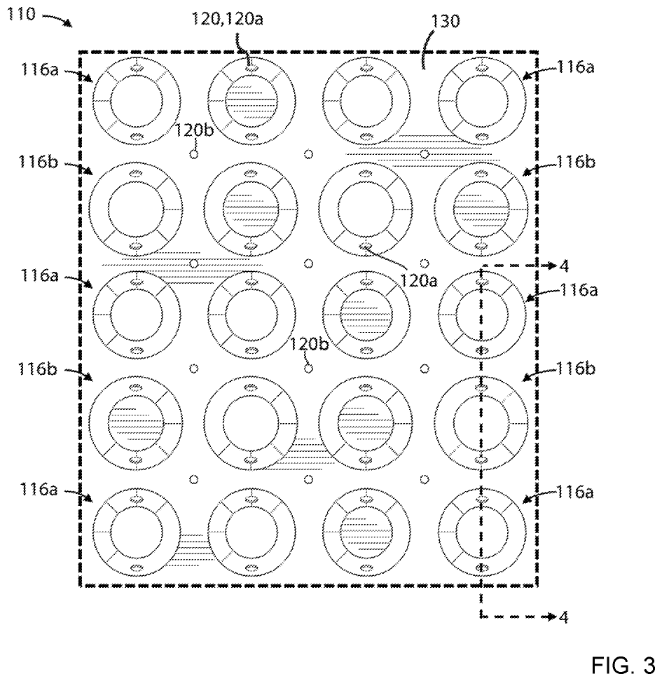

Referring to FIG. 1, an example pipeline assembly 100 is illustrated schematically. Referring to FIG. 2, the pipeline assembly 100 includes a pipe 102 extending along a pipe axis 104 for conveying fluid, an optional insulation layer 106 extending circumferentially about the pipe 102 for insulation thereof, and optional cladding 108 extending circumferentially about the insulation layer 106.

In the example illustrated, the pipeline assembly 100 includes a membrane 110 extending circumferentially about the pipe 102. In the example illustrated, the membrane 110 is positioned radially intermediate the pipe 102 and the insulation layer 106 for decoupling the insulation layer 106 from the pipe 102. Referring to FIG. 3, in the example illustrated, the membrane 110 comprises a substrate 112 extending about the pipe 102. In the example illustrated, the substrate 112 comprises a structural layer of the membrane 110. The substrate 112 includes a panel 114 having an underside surface 114a facing the pipe 102 and a topside surface 114b opposite the underside surface 114a. The topside surface 114b faces the insulation layer 106 in the example illustrated.

In the example illustrated, the substrate 112 has a plurality of protrusions 116 projecting radially therefrom. In the example illustrated, the protrusions 116 space the insulation layer 106 apart from the pipe 102 to provide a radial air gap 118 therebetween.

In the example illustrated, the protrusions 116 include a plurality of underside protrusions 116a projecting from the underside surface 114a and supporting the panel 114 radially apart from the pipe 102. In the example illustrated, the protrusions support the panel 114 radially apart from the pipe 102 to provide an underside radial air gap 118a therebetween. In the example illustrated, the underside protrusions 116a are positioned against and in engagement with an exterior surface of the pipe 102.

In the example illustrated, the protrusions 116 include a plurality of topside protrusions 116b projecting from the topside surface 114b and supporting at least portions of the insulation layer 106 radially apart from the panel 114. In the example illustrated, the topside protrusions 116b support the insulation layer 106 radially apart from the panel 114 to provide a topside radial air gap 118b therebetween. Having topside protrusions 116b in addition to the underside protrusions 116a may, in some cases, provide improved performance relative to membranes lacking topside protrusions, and in which certain types of insulation are positioned directly against the panel without an air gap therebetween.

In the example illustrated, the membrane 110 has a plurality of perforations 120 passing radially through the membrane 110 for permitting gas permeability therethrough. In the example illustrated, the perforations 120 provide fluid communication between the underside and topside air gaps 118a, 118b, which may help improve performance of the membrane 110. Referring to FIG. 3, in the example illustrated, at least some of the perforations 120 (e.g. perforations 120a) pass through the protrusions 116, and at least some of the perforations 120 (e.g. perforations 120b) pass through the panel 114.

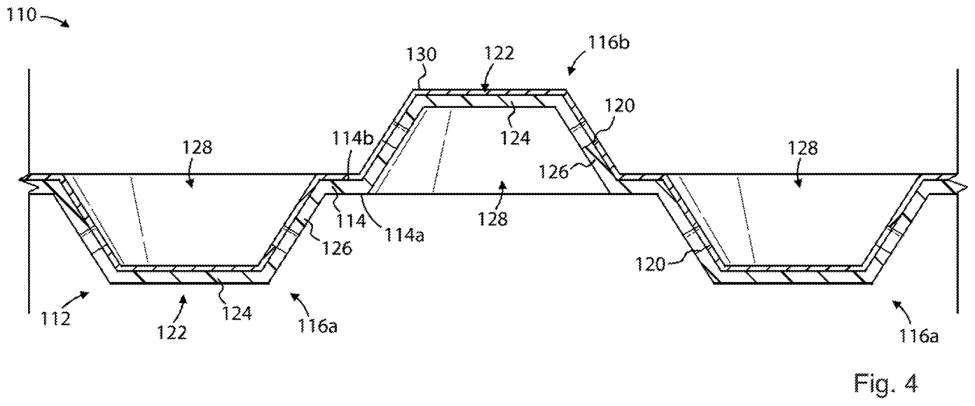

In the example illustrated, the topside protrusions 116b are interspersed between the underside protrusions 116a. Referring to FIG. 4, in the example illustrated, each protrusion 116 comprises a dimple extending from the panel 114 to a tip 122 spaced apart from the panel 114. The dimples can allow for air flow therebetween. The tip 122 of the underside protrusions 116a is positioned adjacent the pipe 102 (FIG. 2A), and the tip 122 of the topside protrusions 116b is positioned adjacent the insulation layer 106 (FIG. 2A). In the example illustrated, each dimple has an endwall 124 comprising the tip 122, a sidewall 126 extending from the panel 114 to the endwall 124, and an interior 128 bounded by the endwall 124 and the sidewall 126. In the example illustrated, the interior 128 of each underside protrusion 116a is open to the topside surface 114b of the panel 114, and the interior 128 of each topside protrusion 116b is open to the underside surface 114a of the panel 114. In the example illustrated, at least some of the perforations 120 pass through the sidewall 126 of the protrusions 116.

In the example illustrated, the membrane 110 further includes a heat-reflecting layer 130 extending over the substrate 112. In the example illustrated, the heat-reflecting layer 130 is radially intermediate the substrate 112 and the insulation layer 106 (FIG. 2A). In the example illustrated, the heat-reflecting layer 130 is bonded to and extends over the panel 114 and the protrusions 116. In the example illustrated, the heat-reflecting layer 130 extends over the topside surface 114b of the panel 114, exterior surfaces of the sidewall 126 and endwall 124 of the topside protrusions 116b, and interior surfaces of the sidewall 126 and endwall 124 of the underside protrusions 116a. In the example illustrated, the perforations 120 pass through the heat-reflecting layer 130. In the example illustrated, the heat-reflecting layer 130 comprises an aluminum lamination.

In the example illustrated, the substrate 112 is of integral, unitary, one-piece construction. The substrate 112 can be formed integrally through, for example, extrusion, thermoforming, and/or injection molding. The substrate 112 can be formed from, for example, polyvinyl chloride (PVC), polyethylene terephthalate (PET), polystyrene, nylon, acrylonitrile butadiene styrene (ABS), and/or acetal. In the example illustrated, the substrate 112 has a substrate thickness, and the substrate thickness can be from between 0.2 mm and 5 mm.

The membrane 110 is generally flexible, and can optionally be rolled up into a roll. The roll can be packaged for shipment and/or sale. In such examples, installation of the membrane 110 includes unrolling the roll and wrapping the membrane 110 around the pipe 102, with the underside protrusions 116a positioned against the exterior surface of the pipe 102. In some examples, another layer can be positioned between the underside protrusions 116a and the pipe 102.

Optionally, the membrane 110 is cut into pieces of desired size for wrapping around the pipe 102. Seams between adjacent pieces of the membrane can be secured together with, for example, suitable tape, to join the pieces together.

Optionally, after the membrane 110 is installed over the pipe 102, the optional insulation layer 106 is placed over the membrane 110. In the example illustrated, the insulation layer 106 is placed against and supported by the topside protrusions 116b. In some examples, another layer can be positioned between the topside protrusions 116b and the insulation layer 106.

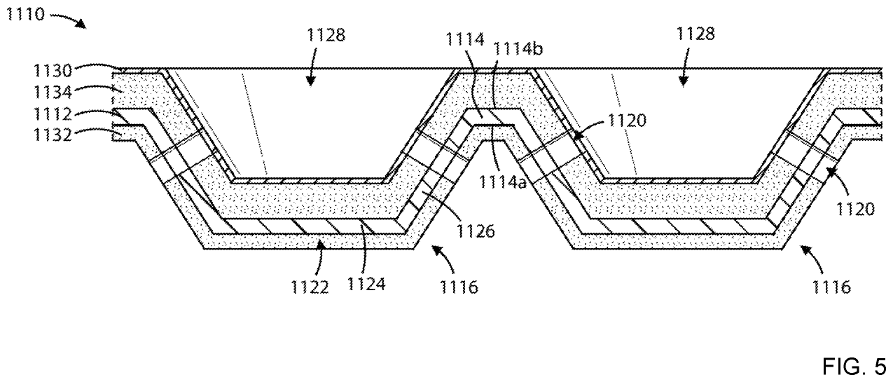

Referring to FIG. 5, another example membrane 1110 for installation circumferentially about a pipe to form a pipeline assembly is illustrated. The membrane 1110 has similarities to the membrane 110, and like features are identified using like reference characters, incremented by 1000. The membrane 1110 can be installed to inhibit heat transfer between external environment and the pipe while promoting air flow around the pipe to help prevent formation of condensation on exterior pipe surfaces, and may be effective without necessarily requiring a separate insulation layer (e.g. like the insulation layer 106).

In the example illustrated, the membrane 1110 comprises a substrate 1112 extending about the pipe. The substrate 1112 has an underside for positioning toward the pipe and a topside opposite the underside. In the example illustrated, the substrate 1112 includes a panel 1114 having an underside surface 1114a on the underside of the substrate 1112 for facing the pipe and a topside surface 1114b on the topside of the substrate 1112 and opposite the underside surface 1114a.

In the example illustrated, the substrate 1112 has a plurality of protrusions 1116 projecting radially therefrom. In the example illustrated, the protrusions 1116 project from the underside surface 1114a and support the panel 1114 radially apart from the pipe. In the example illustrated, the protrusions 1116 support the panel 1114 radially apart from the pipe to provide a radial air gap therebetween. In the example illustrated, the membrane 1110 does not include topside protrusions projecting form the topside surface 1114b.

In the example illustrated, each protrusion 1116 comprises a dimple extending from the panel 1114 to a tip 1122 spaced radially apart from the panel 1114. In the example illustrated, each dimple has an endwall 1124 comprising the tip 1122, a sidewall 1126 extending from the panel 1114 to the endwall 1124, and an interior 1128 bounded by the endwall 1124 and the sidewall 1126 and open to the topside surface 1114b of the panel 1114.

In the example illustrated, the membrane 1110 comprises an optional underside foam layer 1132 on the underside of the substrate 1112. In the example illustrated, the underside foam layer 1132 covers and is bonded to the underside surface 1114a of the panel 1114 and exterior surfaces of the protrusions 1116. The foam layer can be formed of, for example, cross-linked polyethylene, polypropylene, or polyurethane foam.

In the example illustrated, the membrane 1110 comprises a topside foam layer 1134 on the topside of the substrate 1112. In the example illustrated, the topside foam layer 1134 covers and is bonded to the topside surface 1114b of the panel 1114 and interior surfaces of the protrusions 1116. The topside foam layer 1134 can be formed of, for example, cross-linked polyethylene, polypropylene, or polyurethane foam. The topside foam layer 1134 has a foam thickness, and the foam thickness can be between, for example, 0.5 to 25 mm.

In the example illustrated, the membrane 1110 further includes a heat-reflecting layer 1130. In the example illustrated, the heat-reflecting layer extends over the topside foam layer 1134, with the topside foam layer 1134 radially intermediate the substrate 1112 and the heat-reflecting layer 1130. In the example illustrated, the heat-reflecting layer 1130 covers and is bonded to the topside foam layer 1134. The heat-reflecting layer 1130 can comprise, for example, an aluminum lamination.

In the example illustrated, the membrane 1110 has a plurality of perforations 1120 passing radially through the membrane 1110 for permitting gas permeability therethrough. In the example illustrated, the perforations 1120 pass through the sidewall 1126 of the protrusions 1116 (and the heat-reflecting, underside foam, and topside foam layers 130, 132, 134).

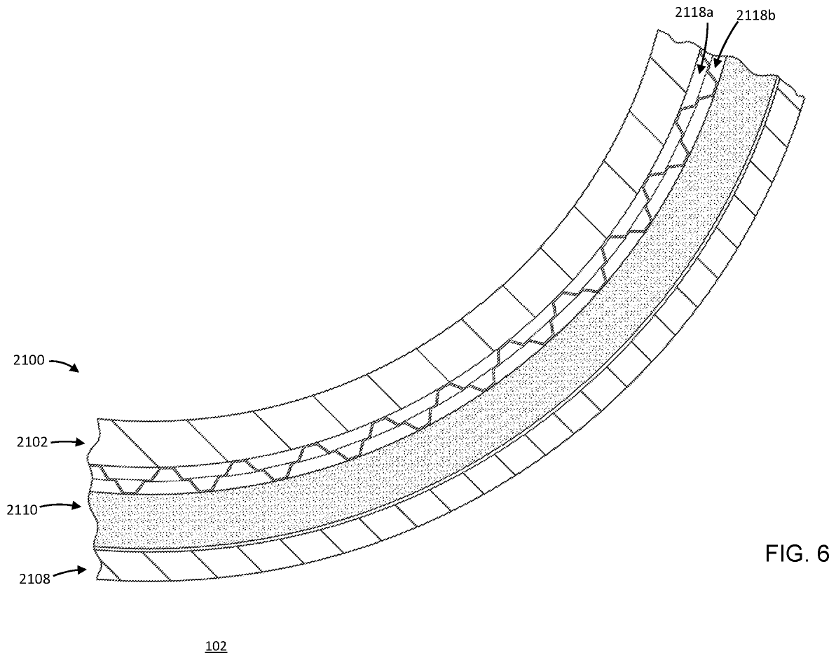

Referring to FIG. 6, a cross-section of a portion of another example pipeline assembly 2100 is illustrated. The pipeline assembly 2100 has similarities to the pipeline assembly 100, and like features are identified using like reference characters, incremented by 2000.

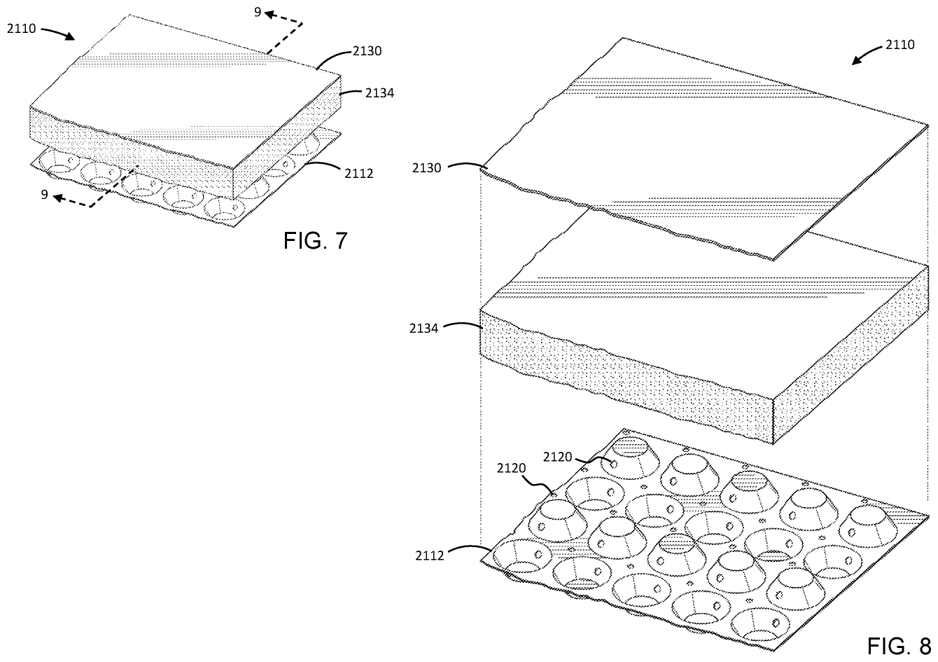

In the example illustrated, the pipeline assembly 2100 includes a membrane 2110 extending circumferentially about a pipe 2102. In the example illustrated, the membrane 2110 is positioned radially intermediate the pipe 2102 and cladding 2108. Referring to FIGS. 7 and 8, in the example illustrated, the membrane 2110 comprises a substrate 2112 for positioning about the pipe. The substrate 2112 has an underside for positioning toward the pipe and a topside opposite the underside. In the example illustrated, the membrane 2110 comprises a foam layer 2134 on the topside of the substrate 2112 (radially intermediate the substrate 2112 and the cladding when the membrane 2110 is installed). In the example illustrated, the membrane 2110 further includes a heat-reflecting layer 2130. In the example illustrated, the heat-reflecting layer 2130 extends over the foam layer 2134 (radially intermediate the foam layer 2134 and the cladding 2108 when the membrane 2110 is installed). In the example illustrated, the foam layer 2134 is between the substrate 2112 and the heat-reflecting layer 2130. In the example illustrated, the heat-reflecting layer 2130 covers and is bonded to the foam layer 2134.

In the example illustrated, the membrane 2110 comprises a one-piece assembly. The foam layer 2134 is bonded to the topside of the substrate 2112 and the heat-reflecting layer 2130 is bonded (e.g. laminated) to the foam layer 2134. This can facilitate packaging for storage, shipment, and/or sale, and deployment and installation of the membrane 2110 at a work site. In some examples, the membrane 2110 can be, for example, rolled up into a roll to facilitate packaging for storage, shipment, and/or sale.

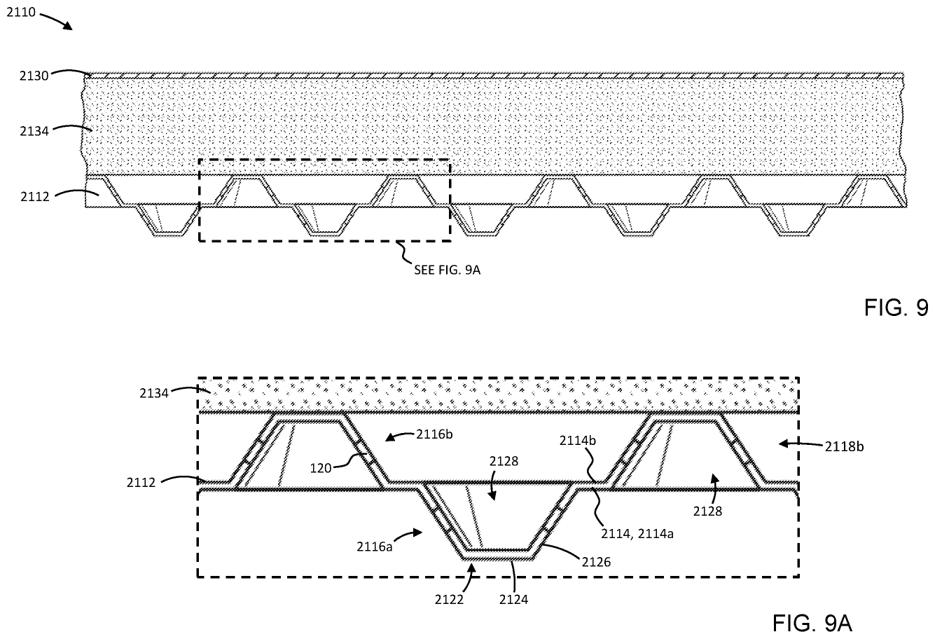

Referring to FIGS. 9 and 9A, in the example illustrated, the substrate 2112 includes a panel 2114 having an underside surface 2114a on the underside of the substrate 2112 for facing the pipe and a topside surface 2114b on the topside of the substrate 2112 and opposite the underside surface 2114a. In the example illustrated, the substrate 2112 has a plurality of protrusions 2116 projecting radially therefrom (i.e. radially relative to the pipe axis 2104 when installed about the pipe). In the example illustrated, the protrusions 2116 include a plurality of underside protrusions 2116a projecting from the underside surface 2114a for supporting the panel 2114 radially apart from the pipe. In the example illustrated, the protrusions 2116 support the panel 2114 radially apart from the pipe 2102 to provide an underside radial air gap 2118a (FIG. 6) therebetween.

Referring to FIGS. 9 and 9A, in the example illustrated, the protrusions 2116 further includes a plurality of topside protrusions 2116b projecting from the topside surface 2114b of the panel 2114, and supporting at least portions of the foam layer 2134 radially apart from the panel 2114. In the example illustrated, the topside protrusions 2116b support the foam layer 22134 radially apart from the panel 2114 to provide a topside radial air gap 2118b therebetween.

In the example illustrated, each protrusion 2116 comprises a dimple extending from the panel 2114 to a tip 2122 spaced radially apart from the panel 2114. In the example illustrated, each dimple has an endwall 2124 comprising the tip 2122, a sidewall 2126 extending from the panel 2114 to the endwall 2124, and an interior 2128 bounded by the endwall 2124 and the sidewall 2126 and open to the topside surface 2114b of the panel 2114. In the example illustrated, the interior 2128 of each underside protrusion 2116a is open to the topside surface 2114b of the panel 2114, and the interior 2128 of each topside protrusion 2116b is open to the underside surface 2114a of the panel 2114.

In the example illustrated, the foam layer 2134 is bonded to the tips 2122 of the topside protrusions 2116b, and is spaced apart from the topside surface 2114a of the panel 2114. The radial spacing between the topside surface 2114a of the panel 2114 and the foam layer 2134 is generally equal to the height (radial extent) of the sidewall 2126 of the topside protrusions.

In the example illustrated, a plurality of perforations 2120 pass through the panel 2114 for permitting gas permeability therethrough. In the example illustrated, the perforations 2120 provide fluid communication between the underside and topside air gaps 2118a, 2118b (FIG. 6). In the example illustrated, at least some of the perforations 2120 pass through the sidewall 2126 of the protrusions 2116, and at least some of the perforations 2120 pass through the panel 2114 (see FIG. 8).

1. A pipeline assembly comprising:
a) a pipe for conveying a fluid therethrough; and
b) a membrane extending circumferentially about the pipe, the membrane comprising a substrate including:
i) a panel having an underside surface facing the pipe and a topside surface opposite the underside surface;
ii) a plurality of underside protrusions projecting from the underside surface and supporting the panel radially apart from the pipe; and
iii) a plurality of topside protrusions projecting from the topside surface.

2. The pipeline assembly of claim 1, wherein a plurality of perforations pass radially through the substrate for permitting gas permeability therethrough.

3. The pipeline assembly of claim 1, wherein the membrane further comprises a foam layer extending over the topside of the substrate and a heat-reflecting layer extending over the foam layer.

4. The pipeline assembly of claim 3, wherein the foam layer is supported by the topside protrusions in spaced apart relation from the topside surface of the panel.

5. The pipeline assembly of claim 3, wherein the membrane comprises a one-piece assembly with the heat-reflecting layer bonded to the foam layer and the foam layer bonded to the substrate.

6. The pipeline assembly of claim 3, wherein the heat-reflecting layer comprises an aluminum lamination.

7. The pipeline assembly of claim 1, wherein each protrusion comprises a dimple extending from the panel to a tip spaced radially apart from the panel, and each dimple has an endwall comprising the tip, a sidewall extending from the panel to the endwall, and an interior bounded by the endwall and the sidewall, the interior of each underside protrusion open to the topside surface of the panel, and the interior of each topside protrusion open to the underside surface of the panel.

8. A membrane for installation circumferentially about a pipe, comprising:
a) a substrate including:
i) a panel having an underside surface on an underside of the substrate for facing the pipe and a topside surface on a topside of the substrate opposite the underside,
ii) a plurality of underside protrusions projecting form the underside surface for supporting the panel radially apart from the pipe; and
iii) a plurality of topside protrusions projecting from the topside surface;
b) a foam layer extending over the topside of the substrate; and
c) a heat-reflecting layer extending over the foam layer.

9. The membrane of claim 8, wherein the foam layer is supported by the topside protrusions in spaced apart relation from the topside surface of the panel.

10. The membrane of claim 8, wherein the membrane comprises a one-piece assembly with the heat-reflecting layer bonded to the foam layer and the foam layer bonded to the substrate.

11. The membrane of claim 8, wherein the heat-reflecting layer comprises an aluminum lamination.

12. The membrane of claim 8, wherein the membrane is rollable into a roll.

13. The membrane of claim 8, wherein a plurality of perforations pass radially through the substrate for permitting gas permeability therethrough.

14. The membrane of claim 8, wherein each protrusion comprises a dimple extending from the panel to a tip spaced radially apart from the panel, and each dimple has an endwall comprising the tip, a sidewall extending from the panel to the endwall, and an interior bounded by the endwall and the sidewall, the interior of each underside protrusion open to the topside surface of the panel, and the interior of each topside protrusion open to the underside surface of the panel.

15. The membrane of claim 8, further comprising an underside foam layer on the underside of the substrate.

16. A membrane for installation circumferentially about a pipe, comprising:
a) a substrate including:
i) a panel having an underside surface for facing the pipe and a topside surface opposite the underside surface,
ii) a plurality of underside protrusions projecting from the underside surface for supporting the panel radially apart from the pipe, and
iii) a plurality of topside protrusions projecting from the topside surface; and
b) a plurality of perforations passing through the substrate for providing gas permeability through the membrane.

17. The membrane of claim 16, wherein the membrane includes a heat reflecting layer extending over the substrate.

18. The membrane of claim 16, further comprising a topside foam layer extending over the topside of the substrate.

19. The membrane of claim 16, further comprising an underside foam layer on the underside of the substrate.

20. The membrane of claim 16, wherein each protrusion comprises a dimple extending from the panel to a tip spaced radially apart from the panel, and each dimple has an endwall comprising the tip, a sidewall extending from the panel to the endwall, and an interior bounded by the endwall and the sidewall, the interior of each underside protrusion open to the topside surface of the panel, and the interior of each topside protrusion open to the underside surface of the panel.
